(19) United States
(12) Patent Application Publication
(10) Pub. No.: US 2023/0216365 A1
(43) Pub. Date: Jul. 6, 2023

(54) ELECTROMAGNETIC COIL

(71) Applicant: MIYAWAKI KOBO CO., LTD., Nagano (JP)

(72) Inventor: Kesatoshi TAKEUCHI, Nagano (JP)

(21) Appl. No.: 17/999,863

(22) PCT Filed: Jun. 11, 2021
(86) PCT No.: PCT/JP2021/022405

§ 371 Date: Nov. 25, 2022

(30) Foreign Application Priority Data
Jun. 12, 2020 (JP) 2020-102556

(51) Int. Cl. H02K 3/47; H02K 3/28; H02K 3/32

(52) U.S. Cl. CPC H02K 3/47; H02K 3/28; H02K 3/32; H02K 41/02

(57) ABSTRACT

An electromagnetic coil where a conductive member is wound so as to surround an air core region includes an effective coil portion, a first coil end portion, and a second coil end portion. The effective coil portion is formed of a coil-use conductive wire formed by bundling a plurality of conductive base members, the first coil end portion is formed of a first end member that is made of a solid conductive material, and the second coil end portion is formed of a second end member made of a solid conductive material. In the air core region of “one magnetic material” to which an electric current of a first phase is supplied, the effective coil portion of “the other electromagnetic coil” to which an electric current of a second phase is supplied is fitted.

### RELATED APPLICATIONS

The present application is a National Phase of International Application No. PCT/JP2021/022405 filed Jun. 11, 2021, which claims priority to Japanese Application No. 2020-102556, filed Jun. 12, 2020.

### TECHNICAL FIELD

The present invention relates to an air-core-type electromagnetic coil.

### BACKGROUND ART

There has been known an electromagnetic coil that is used in a coreless electromechanical device (see patent literature 1, for example).

FIGS. 15A and 15B are views for describing an electromagnetic coil 9A described in patent literature 1. FIG. 15A is a perspective view illustrating an external appearance of the electromagnetic coil 9A, and FIG. 15B is a right side view of the electromagnetic coil 9A.

The electromagnetic coil 9A described in patent literature 1 is, as illustrated in FIG. 15A, wound such that the electromagnetic coil 9A surrounds an air core region 901A. The electromagnetic coil 9A includes: effective coil portions 902A; a first coil end portion 903A that is disposed on one side of the effective coil portions 902A in a longitudinal direction; and a second coil end portion 904A that is disposed on the other side of the effective coil portions 902A in a longitudinal direction. A circuit connection terminal 905A is disposed at the second coil end portion 904A.

The electromagnetic coil described in patent literature 1 includes coils in two kinds of modes consisting of: a first-shape coil (electromagnetic coil 9A) having a shape where the first coil end portion 903A is bent toward a -Z direction side from the longitudinal direction; and a second-shape coil (not illustrated in the drawing) having a shape where the second coil end portion is bent toward a +Z direction side from the longitudinal direction. In the same manner as the first-shape coil, the second-shape coil has an effective coil portion, a first coil end portion and a second coil end portion (not illustrated in the drawing). In the description made hereinafter, there may be cases where the first coil end portion and the second coil end portion are simply referred to as “coil end portion”.

The electromagnetic coil described in patent literature 1 is configured such that the first-shape coil (electromagnetic coil 9A) and the second-shape coil (not illustrated in the drawing) are combined with each other so that, in the air core region of either one of the first-shape coil or the second-shape coil, the effective coil portion of the other of the first-shape coil and the second-shape coil is disposed. With such a configuration, a coil assembly can be easily formed by combining these coils.

### CITATION LIST

### Patent Literature

PTL 1: WO2018/139245

### SUMMARY OF INVENTION

### Technical Problem

The electromagnetic coil described in patent literature 1 (conventional electromagnetic coil) described in patent literature 1 is formed such that a braided wire that is formed by bundling a plurality of conductive base members or the like is used as a coil-use conductive wire, and the coil-use conductive wire is bent. With such a configuration, winding direction switching portions 934A, 944A at the coil end portions inevitably have to take a curved shape with a large radius of curvature.

Although the coil end portions are portions that do not directly contribute to the conversion of energy between electric energy and mechanical energy, due to the above-mentioned circumstance, lengths L903A, L904A that the coil end portions take inevitably become relatively large (also see FIG. 15B). When the lengths L903A, L904A that the coil end portions take become large, a resistance value of the electromagnetic coil 9A also becomes large as a whole. As a result, the attenuation of a start torque of an electromechanical device also becomes large.

In addition, the conventional electromagnetic coil is formed by bending a coil-use conductive wire that is formed by bundling a plurality of conductive base members. Accordingly, in working steps, a disconnection of a wire or a wire diameter strain is liable to occur in winding-direction switching portions 934A, 944A that are portions to be bent (drawbacks that occur in working steps as a disconnection of a wire or a wire diameter strain) Further, at the portion to be bent, irregularity (difference) is liable to occur in elongation of material between the conductive base member that is positioned inside and the conductive base member that is positioned outside, and a strain in impedance is liable to occur due to the above-mentioned irregularity in elongation. A wire in which such drawbacks occur is not limited to a braided wire, and such drawbacks also occur when a litz wire is used as the wire.

On the other hand, in a market, there has been a demand for the suppression of mechanical vibrations by suppressing mechanical resistance of an electromagnetic device. From this point of view, it has been strongly expected that an eddy current in an effective coil portion that is generated along with the movement of a magnet of the electromagnetic device is reduced.

The present invention has been made in view of the above-mentioned circumstances, and it is an object of the present invention to provide an electromagnetic coil that can reduce a size of a coil end portion than the prior art while reducing the generation of an eddy current and, at the same time, can prevent the occurrence of drawbacks that may occur in working steps such as a disconnection of a wire or a wire diameter strain generated in forming a coil-use conductive wire.

### Solution to Problem

According to a first aspect of the present invention, there is provided an electromagnetic coil where a member having conductivity is wound around an air core region, and the member is disposed along a moving direction of a magnet of an electromagnetic device.

The electromagnetic coil includes: an effective coil portion; a first coil end portion positioned on one side of the effective coil portion in a longitudinal direction; and a second coil end portion positioned on the other side of the effective coil portion in the longitudinal direction, the effective coil portion is formed of a coil-use conductive wire formed by bundling a plurality of conductive base members, the first coil end portion is formed of a first end member that is a solid conductive member, the first end member is connected to respective one end sides of one coil-use conductive wire and the other coil-use conductive wire that form the effective coil portion, the first end member being electrically connected between the one coil-use conductive wire and the other coil-use conductive wire, the second coil end portion is formed of a second end member that is a solid conductive member, the second end member being connected to the other end side of at least one of the coil-use conductive wires that form the effective coil portion, and in the air core region of “one said electromagnetic coil” to which an electric current of a first phase is supplied, “the other said electromagnetic coil” to which an electric current of a second phase is supplied is fitted.

According to another aspect of the present invention, there is provided an electromagnetic coil where a member having conductivity is wound around an air core region, and the member is disposed along a moving direction of a magnet of an electromagnetic device.

The electromagnetic coil includes: an effective coil portion; a first coil end portion positioned on one side of the effective coil portion in a longitudinal direction; and a second coil end portion positioned on the other side of the effective coil portion in the longitudinal direction. The electromagnetic coil includes electromagnetic coils of two modes consisting of: a first-shape coil having a shape where the first coil end portion is bent toward a first side from the longitudinal direction; and a second-shape coil having a shape where the second coil end portion is bent toward a second side on a side opposite to the first side from the longitudinal direction. The first-shape coil and the second-shape coil are configured such that, in the air core region of either one of the first-shape coil and the second-shape coil, the effective coil portion of the other of the first-shape coil and the second-shape coil is disposed by combining the first-shape coil and the second-shape coil.

The effective coil portion is formed of a coil-use conductive wire formed by bundling a plurality of conductive base members. The first coil end portion is formed of a first end member that is a solid conductive member. The first end member is directly or indirectly connected to respective one end sides of one coil-use conductive wire and the other coil-use conductive wire that form the effective coil portion. The first end member is electrically connected between the one coil-use conductive wire and the other coil-use conductive wire. The second coil end portion is formed of a second end member that is a solid conductive member. The second end member is directly or indirectly connected to the other end side of at least one of the coil-use conductive wires that form the effective coil portion.

### Advantageous Effects of Invention

According to the coil of the present invention, it is possible to provide the electromagnetic coil where the coil end portion can be made small compared to a conventional electromagnetic coil while reducing the generation of an eddy current. Further, it is possible to eliminate drawbacks on working steps such as the disconnection of a wire and a wire diameter strain generated in forming a coil-use conductive wire.

### BRIEF DESCRIPTION OF DRAWINGS

FIGS. 1A to 1D are perspective views illustrating electromagnetic coils 1A, 1B, and a first coil subassembly 100AS, a second coil subassembly 100BS and a coil assembly 100 that are each formed of a plurality of electromagnetic coils 1A, 1B according to an embodiment.

FIGS. 2A and 2B are views illustrating the electromagnetic coil 1A according to the embodiment 1.

FIG. 3 is a view illustrating a first end member 130A.

FIGS. 4A and 4B are views illustrating a second end member 140A.

FIG. 5 is a flowchart illustrating a method of manufacturing the electromagnetic coil 1A and the electromagnetic coil 1B according to the embodiment 1, and a method of manufacturing the first coil subassembly 100AS, the second coil subassembly 100BS, and the coil assembly 100 according to the embodiment 1.

FIGS. 6A and 6B are views illustrating the preparation of a coil-use conductive wire 110A (braided wire 20).

FIGS. 7A to 7C are views illustrating manufacturing steps (some steps) of the electromagnetic coil 1A according to the embodiment 1.

FIG. 8 is schematic view illustrating the configuration of an experiment in an experimental example.

FIG. 9 is a table illustrating a result of an experiment in the experimental example.

FIGS. 10A to 10C are views illustrating electromagnetic coils 2A, 2B according to the embodiment 2.

FIG. 11 is a view illustrating a state of an electromagnetic coil 2A′ in an insulation layer forming step S180 in the second embodiment.

FIGS. 12A and 12B are views illustrating manufacturing steps (some steps) of an electromagnetic coil 3A according to an embodiment 3.

FIGS. 13A to 13C are views illustrating electromagnetic coils 7, 7′ according to a modification.

FIGS. 14A to 14D are views illustrating electromagnetic coils 8, 8′, 8″ according to a modification.

FIGS. 15A and 15B are views illustrating an electromagnetic coil 9A described in patent literature 1.

### DESCRIPTION OF EMBODIMENTS

Hereinafter, embodiments of electromagnetic coils according to the present invention are described with reference to drawings. The respective drawings are schematic views that each indicate one example, and do not necessarily strictly reflect actual sizes, ratios and the like.

### Embodiment 1

### 1.Configuration of Electromagnetic Coils 1A, 1B According to Embodiment 1

### Overall Structure of Electromagnetic Coils 1A, 1B and Coil Assembly 100

An electromagnetic coil 1 according to the embodiment 1 is an air-core-type electromagnetic coil that is arranged along a moving direction of a magnet of an electromechanical device.

The electromechanical device to which the electromagnetic coil 1 is applied may be any electromechanical device provided that such an electromechanical device uses an air-core-type coil. A coreless motor is one of objects to which the electromagnetic coil 1 is preferably applicable.

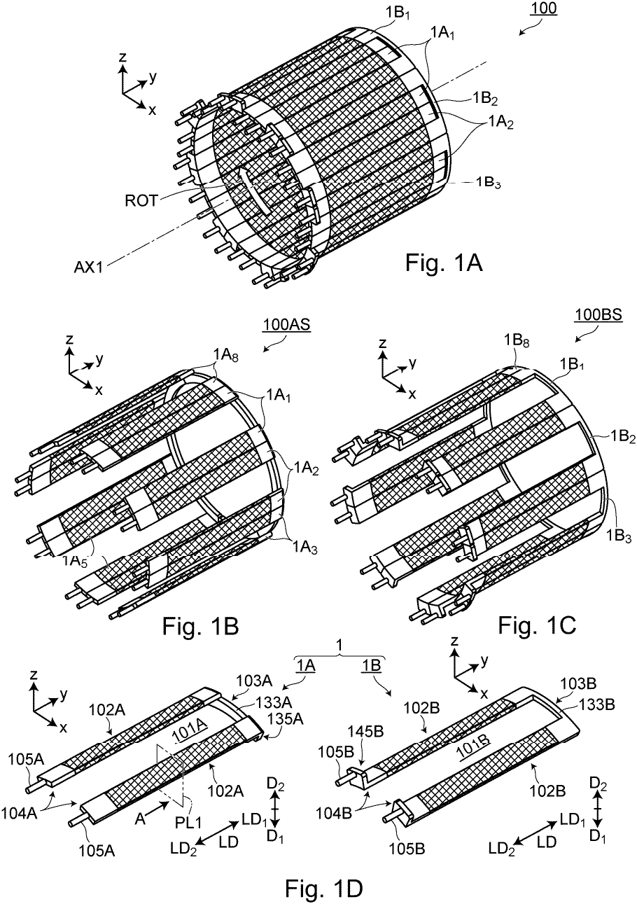

FIG. 1A illustrates one example of a coil assembly 100 of a concentrated-winding-type electromagnetic coil used in a coreless motor. As illustrated in the drawing, in the coil assembly 100, a plurality of electromagnetic coils 1A, 1B (numerals with subscripts being Index numbers) are arranged in a row such that the plurality of electromagnetic coils 1A, 1B are brought into contact with each other along a moving direction ROT of a permanent magnet (not illustrated in the drawing) that forms a rotor. In this manner, the electromagnetic coil 1 is preferably applicable to a so-called coreless motor.

In the drawing, assume a direction parallel to an axis of rotation AX1 of the coreless motor as “y direction”, and assume a direction perpendicular to the axis of rotation AX1 as “x direction” and assume a direction perpendicular to the x direction and the y direction as “z direction”. Further, assume a direction perpendicular to the axis of rotation AX1 in a state where the axis of rotation AX1 forms an initiation point as “radial direction”, and assume a direction orthogonal to the radial direction and parallel to the axis of rotation AX1 in the state where the axis of rotation AX1 forms the initiation point as “circumferential direction”. In the description made hereinafter, also with respect to the electromagnetic coils 1A, 1B that are arranged in accordance with the definitions of these directions, the definitions substantially equal to the above-mentioned definitions relating to the directions are used.

The electromagnetic coil 1 includes, as described hereinafter, coils in two modes, that is, the first-shape coil 1A and the second-shape coil 1B.

A coil assembly 100 (described later) is formed by combining the first-shape coil 1A and the second-shape coil 1B. For example, when the coil assembly 100 is used in an electromechanical device of two-phase driving, a drive current of an A phase can be supplied to the first-shape coil 1A, and a drive current of a B phase can be supplied to the second-shape coil 1B.

In this specification, the first-shape coil 1A is simply referred to as “electromagnetic coil 1A”, and these terms are used in an exchangeable manner. In the same manner, the second-shape coil 1B is simply referred to as “electromagnetic coil 1B”, and these terms are used in an exchangeable manner.

The first-shape coil 1A and the second-shape coil 1B include a large number of constituent components in common and hence, the description is continuously made hereinafter by focusing on the electromagnetic coil 1A (first-shape coil 1A) with reference to FIG. 1A to FIG. 4B.

### Electromagnetic Coil 1A (First-Shape Coil 1A)

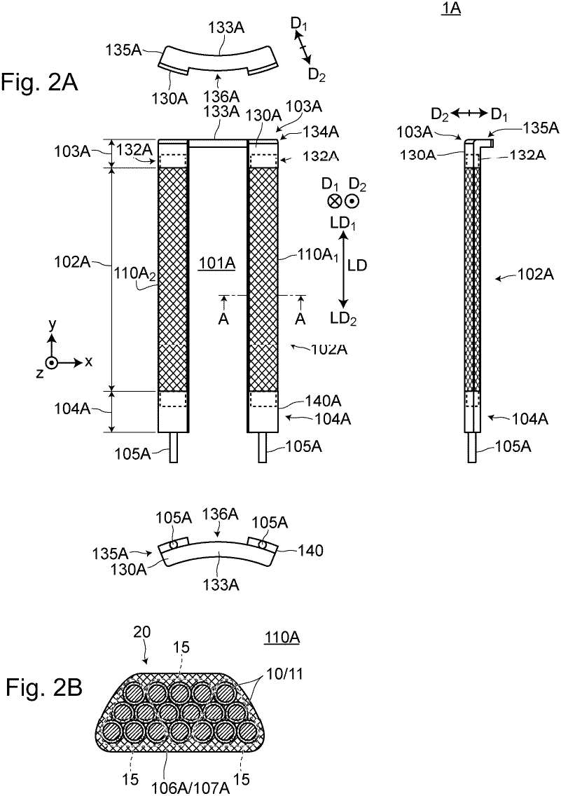

A view on a left side of FIG. 1D is a perspective view illustrating an external appearance of the electromagnetic coil 1A that forms the first-shape coil. FIGS. 2A and 2B are views for illustrating the electromagnetic coil 1A according to the embodiment 1. In FIG. 2A, a view at the center is a plan view of the electromagnetic coil 1A, a view on a lower side is a front view of the electromagnetic coil 1A, a view on an upper side is a back view of the electromagnetic coil 1A, and a view on a right side is a right side view of the electromagnetic coil 1A.

As illustrated in the view on a left side of FIG. 1D and FIG. 2A, the electromagnetic coil 1A is formed by winding a conductive member (described later in detail) around an air core region 101A. In such a configuration, “winding” includes, besides a case where the conductive member is wound around the air core region 101A completely over 360°, a case where the conductive member is not wound the air core region 101A by one turn (a case where the conductive member is not wound around the air core region 101A by 360°) . To additionally describe the configuration for reference purpose, the electromagnetic coil 1A described in the embodiment 1 is formed such that, in the view on the left side of FIG. 1D, starting from circuit connection terminal 105A on a right side, the electromagnetic coil 1A is formed in a counterclockwise direction in order of an effective coil portion 102A (described later), a first coil end portion 103A (described later), and an effective coil portion 102A (described later) and the electromagnetic coil 1A reaches a circuit connection terminal 105A on a left side in the drawing. That is, the electromagnetic coil 1A is wound around the air core region 101A by approximately 0.75 turn.

The electromagnetic coil 1A has: the effective coil portion 102A; the first coil end portion 103A that is positioned at one-side LD1 of a longitudinal direction LD of the effective coil portion 102A; and a second coil end portion 104A that is positioned on the other side LD2 of the longitudinal direction LD of the effective coil portion 102A. The circuit connection terminal 105A is disposed at the second coil end portion 104A.

“Effective coil portion” is a potion that effectively performs energy conversion between electric energy and mechanical energy. Typically, “effective coil portion” is a portion arranged in a positional relationship where the longitudinal direction LD is orthogonal to the moving direction of the magnet. It is also safe to say that “first coil end portion” and “second coil end portion” are portions that do not directly contribute to energy conversion between electric energy and mechanical energy.

In the respective drawings, a pattern similar to a braided wire is depicted on a surface as the effective coil portion 102A. However, in an actual electromagnetic coil 1A, the braided wire is not exposed. The pattern illustrated in the drawing depicts a pattern of an insulation layer 106A (described later) formed so as to trace a pattern of the braided wire. The same goes for displays on the effective coil portions 102A, 102B and the like in other drawings.

The electromagnetic coil 1A (first-shape coil 1A) has a shape where the first coil end portion 103A is bent toward a first side D1 from the longitudinal direction LD. In a case where the coil assembly 100 illustrated in FIG. 1A is estimated, “the first side D1” may be also referred to as “inside in a radial direction”. Symbol 135A indicates an inner diameter protruding portion that protrudes toward the first side D1 as viewed from a side surface.

As illustrated in FIG. 2A, the first coil end portion 103A has a bridge portion 133A. The bridge portion 133A, when the first coil end portion 103A is viewed in a front view along a y direction, is connected between effective coil portions 102A that are disposed on left and right sides. The bridge portion 133A is configured to be located at a position lower than a position where the effective coil portion 102A disposed toward an inner diameter side (first side D1) by one step. In other words, the bridge portion 133A is formed in a shape where the bridge portion 133A is retracted below by one step from a surface on which the effective coil portion 102A is disposed (see the view on the left side of FIG. 1D and FIG. 2A).

With such configuration, a groove region 136A is formed in a region of the electromagnetic coil 1A sandwiched between by effective coil portions 102A disposed on left and right sides. Due to the formation of the groove region 136A, it possible to fit the effective coil portion 102B of the electromagnetic coil 1B in a portion of the groove region 136A of the electromagnetic coil 1A by sliding without generating interreference between the electromagnetic coil 1A and the electromagnetic coil 1B.

The first coil end portion 103A has a winding direction switching portion 134A that is a position where the winding direction of the conductive member is switched. As viewed in a plan view of the electromagnetic coil 1A, with respect to a shape of the conductive member, at the winding direction switching portion 134A, the direction of the conductive member is switched so as to bend at an angle of approximately 90 degrees from the longitudinal direction LD (the direction along the y direction) of the effective coil portion to the direction perpendicular to the longitudinal direction LD of the effective coil portion. That is, the winding direction switching portion 134A is formed in a shape that is bent with a corner instead of a curved shape having a large radius of curvature. The first coil end portion 103A has the winding direction switching portion 134A at two left and right portions respectively.

When the electromagnetic coil 1A is viewed in cross section taken along a plane perpendicular to the axis of rotation AX1 (center axis) of the electromagnetic coil 1A, it is preferable that an external profile of the electromagnetic coil 1A have split ring shapes formed by equally dividing a circular ring by N, and an angle made by two sides of the split ring shapes be equal to or less than 360°/N. The configuration, the manner of operation, and the advantageous effects of this point can be incorporated into this specification by reference to the content described in patent literature 1 that the inventors of the present application previously invented. Further, other technical features can be also incorporated into the present specification by suitably adopting the corresponding technical features without departing from the gist of the present invention.

### Overall Configuration of the Electromagnetic Coil 1B (Second-Shape Coil 1B)

Next, returning to FIG. 1D, the electromagnetic coil 1B is described. A view on a right side of FIG. 1D is perspective view illustrating an external appearance of the electromagnetic coil 1B that forms the second-shape coil.

As illustrated in the drawing on the right side of FIG. 1D, in the electromagnetic coil 1B (second-shape coil 1B), a portion such as the inner diameter protruding portion 135A of the electromagnetic coil 1A does not exist in a first coil end portion 103B. On the other hand, a second coil end portion 104B has a shape bent toward a second side D2 from the longitudinal direction LD. “Second side D2” is a side opposite to the first side D1. In case where the coil assembly 100 illustrated in FIG. 1A is estimated, “second side D2” can be also referred to as “outside in the radial direction”. Symbol 145B indicates an outer diameter protruding portion that protrudes toward the second side D2 as viewed from a side surface.

The electromagnetic coil 1B basically substantially has the same configuration as the electromagnetic coil 1A with respect to the points other than the shape of the first coil end portion 103B and the second coil end portion 104B. Accordingly, the constitutional elements (for example, the effective coil portion 102B, the coil-use conductive wire 110B and the like) that are common with the electromagnetic coil 1A, the electromagnetic coil 1B can be described by using the description relating to the electromagnetic coil 1A of the present specification by changing a suffix A of the symbols to a suffix B.

### Combination of First-Shape Coil 1A and Second-Shape Coil 1B

FIG. 1B is a perspective view of the first coil subassembly 100AS. FIG. 1C is a perspective view of the second coil subassembly 100BS.

As illustrated in FIG. 1B, the first coil subassembly 100AS is formed by arranging N pieces (N being a natural number, 8 pieces in this embodiment) of the electromagnetic coils (first-shape coils 1A). Specifically, the first coil subassembly 100AS is formed such that N pieces of electromagnetic coils 1A are arranged in a ring shape in a state where outer side surfaces of the effective coil portions 102 of the electromagnetic coils 1A disposed adjacently to each other are brough into contact with each other (being made to adhere to each other).

As illustrated in FIG. 1C, the second coil subassembly 100BS is formed by arranging N pieces of electromagnetic coils 1B (second-shape coils 1B) in the same manner. Specifically, the second coil subassembly 100BS is formed such that N pieces of electromagnetic coils 1B are arranged in a ring shape in a state where outer side surfaces of the effective coil portions 102B of the electromagnetic coils 1B disposed adjacently to each other are brough into contact with each other (being made to adhere to each other).

In combining the first-shape coil 1A (electromagnetic coil 1A) and the second-shape coil 1B (electromagnetic coil 1B) to each other, the effective coil portion 102B, 102A of the other coil is disposed in the air core region 101A, 101B of either one coil out of the first-shape coil 1A and the second-shape coil 1B.

To describe the combination and fitting engagement in detail, as described above, the bridge portion 133A of the first coil end portion 103A of the first-shape coil 1A is formed in a shape lowered toward an inner diameter side by one step from the effective coil portion 102A. So that the groove region 136A is formed. The effective coil portion 102B of the second-shape coil 1B is slidable in such a groove region 136A. As a result, the-above-mentioned arrangement can be obtained.

With the configuration described above, the coil assembly 100 can be formed by combining the first coil subassembly 100AS (see FIG. 1B) and the second coil subassembly 100BS (see FIG. 1C) by sliding the second coil subassembly 100BS from the right side to the left side of the first coil subassembly 100AS (see FIG. 1A). In such a configuration, for example, in the air core region of the first-shape coil (electromagnetic coil 1A₁), the effective coil portion of the second-shape coil (electromagnetic coil 1B₁, 1B₂) is disposed.

### Detail Electromagnetic Coil 1A (First-Shape Coil)

Returning to FIGS. 2A and 2B again, the description is continued with respect to the detail of the electromagnetic coil 1A.

### 1) Coil-Use Conductive Wire 110A

FIG. 2B is cross sectional view when a cut plane formed by cutting the effective coil portion 102A of the electromagnetic coil 1A by an imaginary plane PL1 illustrated in FIG. 1D in a direction indicated by an arrow A.

As illustrated in FIG. 2B, the effective coil portion 102A is formed of the coil-use conductive wire 110A that is formed by bundling a plurality of conductive base members 10. In this case, “coil-use conductive wire 110A that is formed by bundling a plurality of conductive base members 10” may be also referred to as the coil-use conductive wire 110A formed by twisting (stranding) a plurality of conductive base members 10 or/and by braiding a plurality of conductive base members 10.

As “conductive base members 10”, in this embodiment, bare conductive wires 11 are adopted.

“bare conductive wires 11” refers to wires in a state where a periphery of each wire is not covered by an insulation material by coating so that a conductor that is the conductive member is exposed. For example, besides a solid “bare copper wire” that uses copper as a main material, “carbon wire” that uses carbon, “plated wire” that is formed by applying tin plating, nickel plating or the like to a bare copper wire” are included in “bare conductive wire 11”. In an example described hereinafter, a tin plated wire is used.

A diameter of the conductive base member 10 can be suitably selected in accordance with the specification of the electromechanical device. With respect to a wire that is used as the conductive base member 10, as a conductive wire that contains copper, the conductive base member 10 preferably has an average radius of 20 µm or less. Further, it is more preferable that the conductive base member 10 preferably have an average radius of 100 µm or less. It is still more preferable that the conductive base member 10 preferably have an average radius of 50 µm or less. This is because the occurrence of an eddy current can be reduced by adopting the conductive base member 10 having such a diameter (the detail being described later in [Experiment]).

The coil-use conductive wire 110A is formed of the braided wire 20 that is formed by braiding a plurality of bare conductive wire 11. Specifically, for example, as illustrated in FIG. 2B, the coil-use conductive wire 110A is formed such that a twisted wire 15 formed by twisting 6 pieces of bare conductive wire 11 is used as an intermediate member, and three sets of twisted wires 15 are braided so as to form the braided wire 20. By forming the coil-use conductive wire 110A into such a configuration, the generation of an eddy current can be reduced (the detail being described in detail in [Experiment] ) .

The insulation layer 106A is formed on at least a surface of the braided wire 20.

The insulation layer 106A may be any member provided that the insulation layer 106A is an insulation member.

In the embodiment 1, the insulation layer at least at the effective coil portion 102A is an insulation layer 107A obtained by making a water soluble material impregnate into a periphery of the conductive base member 10 and by solidifying the impregnated water soluble material. It is preferable that the insulation layer 107A be an electrodeposited insulation coating film formed on the periphery of the conductive base member 10. In this embodiment, in other words, the insulation layer 107A is an electrodeposited insulation coating film obtained by applying electrodeposited coating to the conductive base member 10. The electrodeposited insulation coating film that forms the insulation layer 107A covers the conductive base member 10 as a film, and is made of an insulation material and has an insulation function.

On the other hand, even in a case where the insulation layer 106A at the effective coil portion 102A is an insulation coating film formed around the conductive base member 10, such a configuration is also preferably adopted. This is because the relatively inexpensive insulation layer 106A can be formed so that the electromagnetic coil 1 that is also economically advantageous can be obtained. In this embodiment, in other words, the insulation layer 106A is “an insulation coating film (excluding an electrodeposited insulation coating film) that is obtained by applying an insulation coating material to the conductive base member 10. The insulation coating film that forms the insulation layer 106A covers the conductive base member 10 as a film, and is made of an insulation material and has an insulation function.

The coil-use conductive wire 110A includes the braided wire 20 and the insulation layer 106A described above.

### 2) First End Member 130A

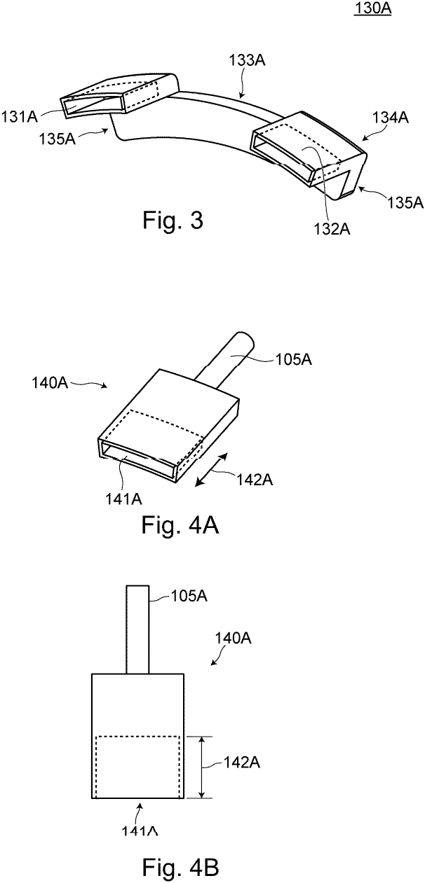

FIG. 3 is a view (perspective view) for describing the first end member 130A.

As illustrated in FIG. 3, the first coil end portion 103A is formed of a first end member 130A that is a solid conductive member.

Here, “solid conductive member” is one variation of “conductive material” and is a conductive member that forms a single body different from a bundle of wires (wire members). For example, the solid conductive member (material) may be made of metal that contains copper and may be formed into a predetermine shape by casting or forging. The solid conductive member may be a member formed by pressing a copper plate (a plate obtained by applying rolling to metal that contains copper) into a predetermined shape.

For example, an opening portion 131A is formed on the first end member 130A (see FIG. 3). This opening portion 131A allows the first end member 130A to receive and engage with one end side 111A of the coil-use conductive wire 110A₁, 110A₂ by fitting engagement (see FIG. 3).

The first end member 130A is connected to one end side (LD1 side) of one coil-use conductive wire 110A that forms the effective coil portion 102A (for example, the coil-use conductive wire 110A₁ on a right side of a plan view at the center in FIG. 2A) and to one end side (LD1 side) of the coil-use conductive wire 110A that forms the effective coil portion 102A (for example, the coil-use conductive wire 110A₂ on a left side of the plan view at the center in FIG. 2A), and the electrical connection is established between one coil-use conductive wire 110A₁ and the other coil-use conductive wire 110A₂. In such a configuration, “connection” includes, besides the case where the coil-use conductive wire 110A₁ and the coil-use conductive wire 110A₂ are directly connected to each other as the embodiment 1, but also the case where the coil-use conductive wire 110A₁ and the coil-use conductive wire 110A₂ are indirectly connected to each other by way of a spacer 40 or the like as in an embodiment 2 (the embodiment 2 being described later).

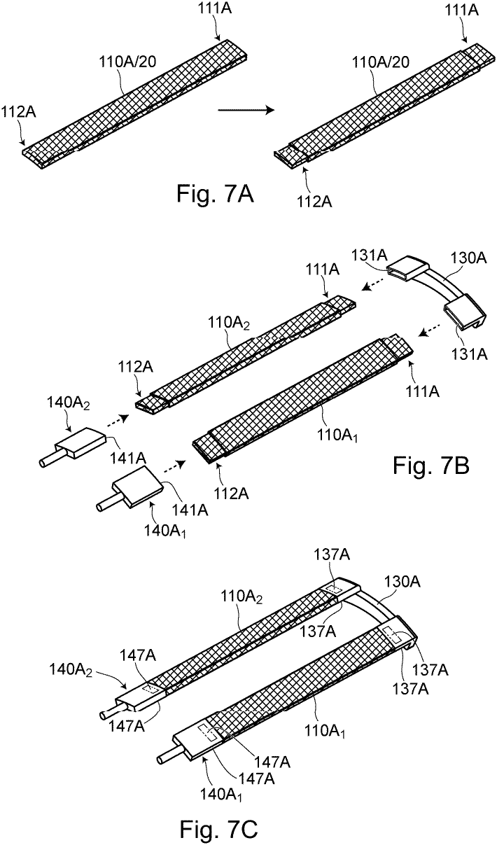

When the first end member 130A is incorporated as a portion of the electromagnetic coil 1A, the following structure is established. That is, while the solid conductive member is made of metal, the first end member 130A is fixed to one end side of the coil-use conductive wire 110A by crimping. More specifically, the first end member 130A is strongly fixed to the coil-use conductive wire 110 such that, in a state where one end side 111A of the coil-use conductive wire 110A is fitted and inserted into the opening portion 131A of the first end member 130A, an inner side wall of the opening portion 131A of the first end member 130A “crimps” the one end side 111A of the coil-use conductive wire 110A (see FIG. 2A, FIG. 3, FIG. 7B described later and the like).

An insertion margin of the coil-use conductive wire 110A into the opening portion 131A of the first end member 130A becomes the connection portion 132A of the coil-use conductive wire 110A. Such a connection portion 132A may be also referred to as an overlapping portion 132A. In the electromagnetic coil 1A in an assembled state, the first end member 130A and the coil-use conductive wire 110A are closely connected to each other and are electrically connected to each other at the overlapping portion 132A.

The first end member 130A is bent at an approximately 90° at a corner as viewed in a plan view. Such a bent portion forms “winding direction switching portion 134A” when the first end member 130A is assembled into the electromagnetic coil 1A. (see a plan view at the center of FIG. 2A.

The first end member 130A has, besides the above-mentioned structures, structure that correspond to the structures that have been described with reference to the first coil end portion 103A such as the inner diameter protruding portion 135A, the bridge portion 133A, the obliquely formed side and the like. Accordingly, the description of the first coil end portion 103A is used for the description of these structures with modifications.

### 3) Second End Member 140A

FIGS. 4A and 4B are views illustrating the second end member 140A. FIG. 4A is a perspective view of the second end member 140A, and FIG. 4B is a plan view of the second end member 140A respectively.

As illustrated in FIGS. 4A and 4B, the second coil end portion 104A is formed of a second end member 140 that is a solid conductive member. FIG. 4A is a perspective view of the second end member 140A, and FIG. 4B is a plan view of the second end member 140A.

As illustrated in FIGS. 4A and 4B, the second end portion 104A is formed of a second end member 140A that is a solid conductive member.

An opening portion 141A is formed on the second end member 140A. This opening portion 141A allows the second end member 140A to receive and engage with the other end side (LD2 side) of the coil-use conductive wire 110A₁, 110A₂ by fitting engagement (see a plan view at the center in FIG. 2A) . Further, a circuit connection terminal 105A is disposed in the second end member 140A.

The second end member 140A is connected to the other end side of the coil-use conductive wire 110A₁, 110A₂ that forms the effective coil portion 102A (see FIG. 2A). In such a configuration, “connection” includes, besides the case where the coil-use conductive wire 110A₁ and the coil-use conductive wire 110A₂ are directly connected to each other, the case where the coil-use conductive wire 110A₁ and the coil-use conductive wire 110A₂ are indirectly connected to each other via the spacer 40 or the like as in the embodiment 2 (the embodiment 2 being described later).

When the second end member 140B is incorporated as a portion of the electromagnetic coil 1A, the following structure is established. That is, while the solid conductive member is made of metal, the second end member 140A is fixed to the other end side of the coil-use conductive wire 110A by crimping. More specifically, the second end member 140A is strongly fixed to the coil-use conductive wire 110A such that, in a state where the other end side 112A of the coil-use conductive wire 110A is fitted and inserted into the opening portion 141A of the second end member 140A, an inner side wall of the opening portion 141A of the second end member 140A “crimps” the other end side 112A of the coil-use conductive wire 110A (also see FIG. 7B described later and the like).

An insertion margin of the coil-use conductive wire 110A into the opening portion 141A of the second end member 140A becomes the connection portion 142A of the coil-use conductive wire 110A. Such a connection portion 142A may be also referred to as an overlapping portion 142A. In the electromagnetic coil 1A in an assembled state, the second end member 140A and the coil-use conductive wire 110A are closely connected to each other and are electrically connected to each other at the overlapping portion 142A.

One end side of the coil-use conductive wire 110A is fixed by crimping at the overlapping portion 132A of the first end member 130A, and the other end side of the coil-use conductive wire 110A is fixed by caulking at the overlapping portion 142A of the second end member 140A. In the above-mentioned configuration, for a reference purpose, with respect to the coil-use conductive wire 110A, a portion other than the above-mentioned overlapping portion 132A, 142A forms the effective coil portion 102A. Further, a portion of the first end member 130A forms the first coil end portion 103A, and the second end member 140A (excluding a portion of the circuit connection terminal 105A) forms the second coil end portion 104A (see a plan view at the center in FIG. 2A).

### 4) Insulation Layer 106A

In the electromagnetic coil 1A, an insulation layer 106 is formed on at least a surface of an entire region other than the circuit connection terminals 105A. In this embodiment, it may be safe to say that “entire region” is specifically an entire surface of regions of all of the first end members 130A, the coil-use conductive wires 110A and the second end members of the electromagnetic coil 1A (excluding portions of the circuit connection terminals 105A). The insulation layers on the first end member 130A and the second end member 140A may adopt the same configuration as the insulation layers 106A formed on the above-mentioned coil-use conductive wires 110A (braided wires 20). It is needless to say that insulation layers having the configuration that differ from the configuration of the insulation layers 106A formed on the coil-use conductive wires 110A (braided wires 20) may be adopted.

### Detail of Electromagnetic Coil 1B (Second-Shape Coil 1B)

As described above, the electromagnetic coil 1B (second-shape coil 1B) has basically substantially the same configuration as the electromagnetic coil 1A (first-shape coil 1A) with respect to the points other than the shape of the first coil end portion 103B and the shape of the second coil end portion 104B. Accordingly, the description of the electromagnetic coil 1A is also used as the description of the electromagnetic coil 1B.

### 2. Method of Manufacturing Electromagnetic Coils 1A, 1B According to Embodiment 1

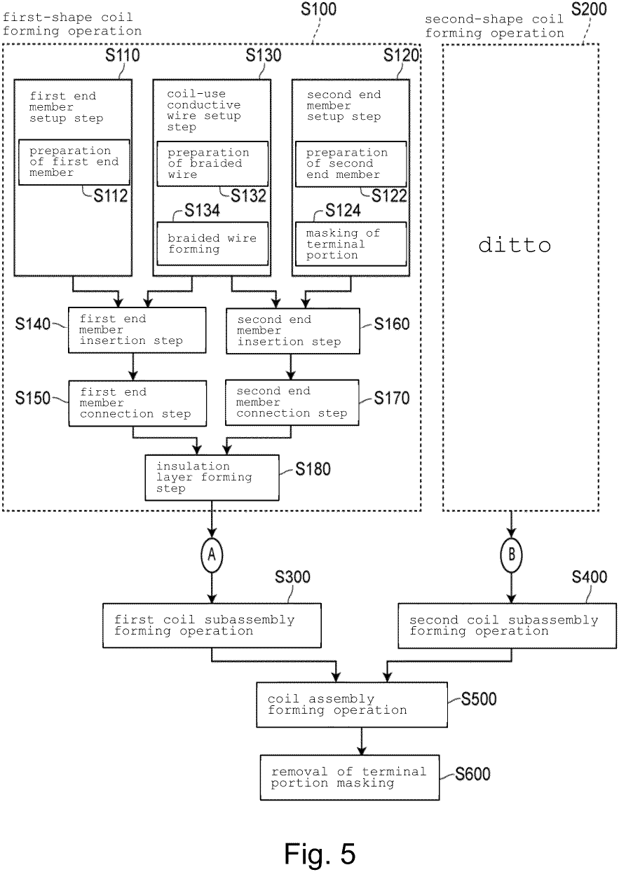

FIG. 5 is a flow chart for describing a method of manufacturing the electromagnetic coil 1A (first-shape coil 1A) and the electromagnetic coil 1B (second-shape coil 1B) and a method of manufacturing the first coil subassembly 100AS, the second coil subassembly 100BS and the coil assembly 100 according to the embodiment 1.

As illustrated in FIG. 5, the method of manufacturing the electromagnetic coil 1A according to the embodiment 1 includes, to roughly grasp the steps/processes of the method, “pre-process”, “intermediate-process” and “post-process”. In the method, “pre-process” includes a first end member preparation step S110, a second end member preparation step S120 and a coil-use conductive wire setup step S130. In the method, “intermediate-process” includes a first end member insertion step S140 and a first end member connection step S150, and a second end member insertion step S160 and a second end member connection step S170. In the method, “post-process” includes an insulation layer forming step S180. All these steps are collectively referred to as “first-shape coil forming operation S100”.

On the other hand, the method of manufacturing the electromagnetic coil 1B has substantially the same configuration and hence, the entire steps are collectively referred to as “second-shape coil forming operation S200”.

Hereinafter, the description is continued by estimating a case where “the coil-use conductive wire 110A formed by bundling the plurality of conductive base members” is formed by braided wires 20 by focusing on the electromagnetic coil 1A.

### A. Method of Manufacturing Electromagnetic Coil 1A (First-Shape Coil 1A)

### First End Member Setup Step S110

The first end member setup step S110 is a step where pre setup for the intermediate-process is performed by performing the preparation of the first end member 130A illustrated in FIG. 3 (first end member preparation step S112) and the like.

### Second End Member Setup Step S120

The second end member setup step S120 is a step where pre setup for the intermediate-process is performed by performing the preparation of the second end member 140A illustrated in FIGS. 4A and 4B (second end member preparation step S122) and the like.

In this step, masking may be applied to the circuit connection terminals 105A in advance (terminal portion masking step S124). Specifically, masking is performed in advance by applying a permeable insulation coating material such as polyesterimide, polyamide imide, polyimide, enamel, urethane, varnish or the like to the circuit connection terminals 105A. Such treatment is performed so as to prevent the circuit connection terminals 105A from being affected by an insulation material in an insulation layer forming step S180 described later.

### Coil-Use Conductive Wire Setup Step S130

The coil-use conductive wire setup step S130 is a step of setting up the coil-use conductive wire 110A for succeeding steps (insertion, fitting and connection to the first end member) by preparing the coil-use conductive wires 110A. The coil-use conductive wire set up step S130 includes a braided wire preparation step S132 and a braided wire forming step S134.

### 1) Braided Wire Preparation Step S132

The braided wire preparation step S132 is a step where the braided wire 20 that forms the coil-use conductive wire 110A is formed and prepared.

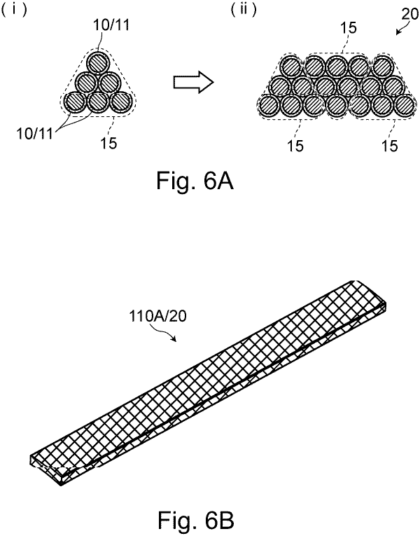

FIGS. 6A and 6B are views illustrating the preparation of the coil-use conductive wire 110A (braided wire 20). FIG. 6A is a cross-sectional view obtained by cutting twisted wires 15 or the braided wire 20 in a plane perpendicular to the longitudinal direction.

In the braided wire preparation step S132, first, the twisted wire 15 is formed by twisting (stranding) the 6 pieces of bare conductive wires 11 (estimating tin plated wires in this embodiment) as the conductive base member 10, and this conductive base member 10 is used as an intermediate member (see FIG. 6A(i)). Next, 3 sets of twisted wires 15 are assembled, and these assembled twisted wires 15 are braided with each other thus forming the braided wire 20 (see FIG. 6A(ii)). At this stage, forming may be lightly performed by pressing the whole periphery of the braided wire 20 from the outside. The braided wire 20 formed in this manner becomes the coil-use conductive wire 110A of an approximately plate shape having a predetermined thickness as illustrated in FIG. 6B that is a perspective view.

In the electromagnetic coil 1A according to the embodiment 1, two coil-use conductive wires 110A are used in the effective coil portion 102A, and two coil-use conductive wires 110B are used in the effective coil portion 102B in the electromagnetic coil 1B. It is preferable that these four coil-use conductive wires 110A, 110B in total have the common specification. By allowing four coil-use conductive wires 110A, 110B to have such specification, in the braided wire preparation step S132, required number of braided wires 20 are collectively formed by batch treatment.

### 2) Braided Wire Forming Step S134

FIGS. 7A to 7C are views illustrating a manufacturing step (a part) of the electromagnetic coil 1A according to the embodiment 1. FIG. 7A is a perspective view illustrating braided wire forming step S134.

In braided wire forming step S134, first, the braided wire 20 is adjusted to a predetermined length by cutting or the like (see a drawing on a left side of FIG. 7A). Next, at one end side 111A and the other end side 112A that are both end portions of the braided wire 20, outer diameter sizes of both end portions of the braided wire 20 are decreased by collapsing peripheries of both end portions from the outside over a predetermined length (a length corresponding to the above-mentioned overlapping portion 142A) (see a drawing on a right side in FIG. 7A). With such a step, both end portions of the braided wire 20 are formed such that both end portions can be inserted into the opening portion 131A of the first end member 130A and the opening portion 141A of the second end member 140A.

### First End Member Insertion Step S140

FIG. 7B is a perspective view illustrating the first end member insertion step S140 and the second end member insertion step S160.

The first end member insertion step S140 is a step where one end side 111A of the coil-use conductive wire 110A (braided wire 20) whose outer profile size is made small by collapsing coil-use conductive wire 110A in the braided wire forming step S134 is inserted into the opening portion 131A of the first end member 130A so that one end side 111A engages with the overlapping portion 132A by fitting engagement (see FIG. 7B).

### First End Member Connection Step S150

FIG. 7C is a perspective view illustrating the first end member connection step S150 and the second end member connection step S170.

The first end member connection step S150 is a step where the first end member 130A fitted in the first end member insertion step S140 and the coil-use conductive wire 110A are strongly connected to each other (see FIG. 7C).

The connection between the first end member 130A and the coil-use conductive wire 110A may be performed by crimp fixing. The crimp fixing is performed such that, for example, the overlapping portion 132A of the first end member 130A is plastically deformed by applying a pressure to a predetermined portion of the first end member 130A in the overlapping portion 132A from the outside of the first end member 130A (see a portion to be crimped 137A in FIG. 7C) using a crimping tool or the like. As a result, the wall of the inside of the opening portion 131A of the first end member 130A strongly presses an outer periphery of the coil-use conductive wire 110A. Accordingly, the first end member 130A is strongly fixed to one end side 111A of the coil-use conductive wire 110A in a close contact manner and is electrically connected to the coil-use conductive wire 110A.

After the above-mentioned crimp fixing is performed, treatment for bonding and fixing the first end member 130A and the coil-use conductive wire 110A may be further applied by using a material having conductivity such as solder.

### Second End Member Insertion Step S160 and Second end Member Connection Step S170

The second end member insertion step S160 is a step where the other end side 112A of the coil-use conductive wire 110A whose outer profile size is made small by collapsing in the braided wire forming step S134 is inserted into the opening portion 141A of the second end member 140A, and is fitted into the overlapping portion 142A (see FIG. 7B).

The second end member connection step S170 is a step where the second member 140A that is fitted into the second end member insertion step S160 and the coil-use conductive wire 110A are strongly connected to each other (see FIG. 7C). In the same manner as the first end member connection step S150, using a crimping tool or the like, the second end member 140A and the coil-use conductive wire 110A may be connected to each other by applying crimp fixing to the portion to be crimped 147A positioned in the overlapping portion 142A of the second end member 140A.

The second end member insertion step S160 and the second end member connection step S170 can be performed basically with the same content as the above-mentioned first end member insertion step S140 and the first end member connection step S150.

### Insulation Layer Forming Step S180

The insulation layer forming step S180 is a step where the insulation layer 106A is formed at least on a surface of the regions (portions)other than the circuit connection terminals 105A.

Although not illustrated in the drawings, as the insulation layer forming step S180, it is preferable to perform an impregnation step of impregnating a water soluble material that uses a solute having insulation property into at least the coil-use conductive wire 110A, and a solidifying step of solidifying the impregnated water soluble material in this order. In this case, it is preferable to adopt a material having insulation property and adhesiveness as the water-soluble material.

In the impregnating step, together with the above-mentioned treatment, it may be possible to perform treatment for making the above-mentioned water soluble material also to a surface of the first end member 130A and a surface of the second end member 140A (excluding masked portions)

The insulation layer forming step S180 may be performed as follows, for example. That is, the inside of a liquid vessel, a container or the like (hereinafter simply referred to as “liquid vessel”) is filled with a solution of a thermosetting resin and, thereafter, an electromagnetic coil to which the first end member connection step S150 and the second end member connection step S170 are performed (conducted) is cast into the liquid vessel. As a result, the water soluble material impregnates (intrudes) between a plurality of conductive base members 10 that form the coil-use conductive wire 110A. In this case, a water soluble material adheres also to surfaces of the first end member 130A and the second end member 140A (excluding the masked portions). In such a state where a water soluble material adheres to a periphery of the conductive base members 10 and the like, the coil-use conducive wires 110A, the first end member 130A and the second end member 140A (objects to be coated) are pulled out from the liquid vessel. Then, the objects to be coated to which the water soluble material adheres are heated so that a material derived from the water soluble material that adheres to the periphery of the objects to be coated is solidified.

Further, it is preferable to perform impregnation and solidifying of the water soluble material by so-called electrodeposited insulation coating.

For example, a liquid vessel is filled with an aqueous solution that contains a water soluble material, and objects to be coated are cast into the inside of a bath in a state where on object to be coated is completely immersed into the aqueous solution. With such an operation, the water soluble material impregnates (intrudes) between a plurality of conductive base members 10 that form the coil-use conductive wires 110A out of the objects to be coated. In such a state, a direct current voltage is applied so as to control a film thickness of an insulation film between the objects to be coated and an electrode. As a result, an electrodeposited insulation coating film attributed to a water soluble material precipitates on surfaces of the periphery of the coil-use conducive wire 110A (the conductive base members 10 microscopically), the first end member 130A and the second end member 140A (excluding masked portions). Accordingly, an insulation layer 106A that forms an electrodeposited coating film can be formed on surfaces of the periphery of the conductive base members 10, the first end member 130A and the second end member 140A (excluding masked portions).

In applying a direct current voltage, ultrasonic waves may be applied to an aqueous solution in the liquid vessel. Bubble and impurities can be removed from the peripheries of the objects to be coated by applying the ultrasonic waves so that insulation property can be enhanced.

The formation of the insulation layer 106A is not limited to the above-mentioned electrodeposited insulation coating. For example, although not illustrated in the drawings, an insulation coating film may be formed by applying an insulation material by coating to surfaces of the peripheries of the conductive base members 10 of the coil-use conductive wires 110A, the first end member 130A and the second end member 140A (excluding masked portions), and the insulation coating film is used as the insulation layer 106A. According to such a method of forming the insulation coating film by coating, compared to the electrodeposited insulation coating, the insulation layer 106 can be formed in an inexpensive manner and hence, it is possible to acquire the coil that is also economically advantageous.

### B. Method of Manufacturing Electromagnetic Coil 1B (Second-Shape Coil 1B)

The electromagnetic film 1B can also be obtained by preforming substantially the same steps as the corresponding steps of the above-mentioned method of manufacturing the electromagnetic coil 1A. (see the second-shape coil forming operation illustrated in FIG. 5).

By performing the steps described above, it is possible to obtain the electromagnetic coils 1A, 1B according to the embodiment 1).

For reference purpose, after the respective electromagnetic coils 1A, 1B are obtained, a first coil subassembly forming operation S300, a second coil subassembly forming operation S400, and a coil assembly forming operation S500 can be performed (with respect to the detail of these operations, see the above-mentioned chapter “1. Configuration of electromagnetic coils 1A, 1B″). Further, after the coil assembly is completed by the coil assembly forming operation S500, with respect to masking applied to the circuit connection terminal 105A, for example, masking can be selectively removed by heating in a soldering furnace, for example (a terminal portion masking removal operation S600) .

### 3. Experiment

The inventors carried out an experiment relating to the generation of an eddy current when a magnet of an electromechanical device was moved, and made a novel finding with respect to a coil that suppresses the generation of an eddy current. The experiment is described hereinafter.

### Configuration of Experiment

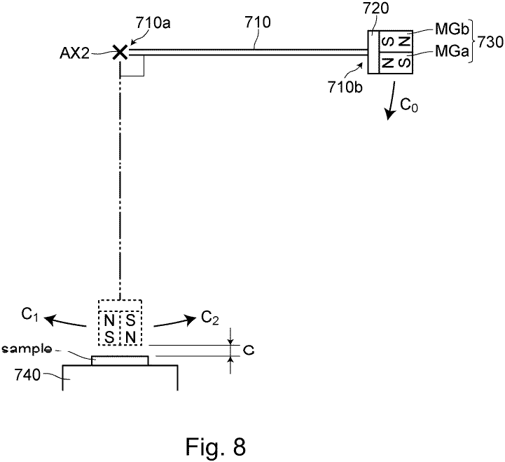

FIG. 8 is a schematic view illustrating the configuration of an experiment.

To schematically reproduce the movement of a magnet in an electromechanical device, as shown in FIG. 8, an experiment jig having a pendulum shape is formed. Specifically, permanent magnets MGa, MGb are disposed on one end side 710b of a rod 710 by way of a fixing member 720 (symbol 730 indicating the permanent magnets MGa, MGb that form a pair), and the other end side 710a of the rod 710 is fixed to a rotary shaft AX2. The other end side 710a of the rod 710 is connected to a bearing shaft and is set rotatable under a low friction coefficient.

On a premise of such a configuration, a sample (referred to as Sample in the drawing) is disposed just below the rotary shaft AX2. The sample is fixed to an upper surface of a sample fixing base 740 made of a non-magnetic body. A gap G is formed between a level of an upper surface of the Sample and the pair of permanent magnets 730 disposed on a distal end of the pendulum so as to prevent the Sample and the pair of permanent magnets 730 from being brought into contact with each other spatially.

### Sample and Experiment Method

### 1) Sample

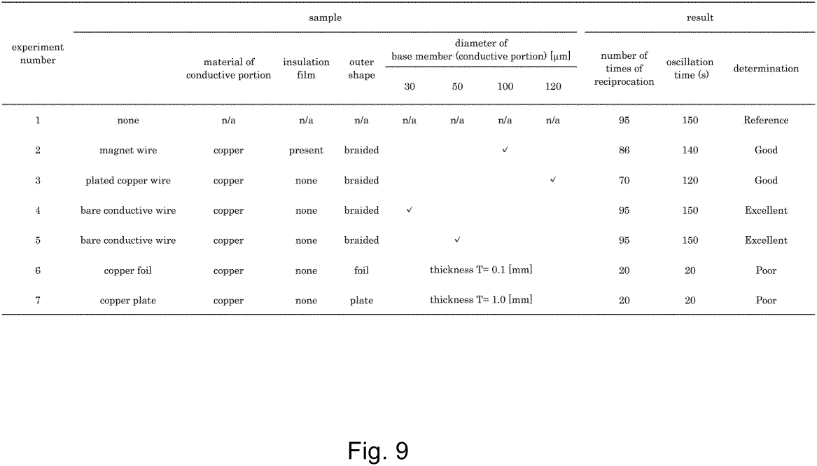

Basically, an electromagnetic coil is estimated as Sample. Specifically, various candidates for materials of “members having conductivity (for example, the conductive base member 10, the coil-use conductive wire 110A, the first end member 130A and the second end member 140A) are estimated, and these Samples were served in the experiment. Various materials indicated in a second row of a table illustrated in FIG. 9 (described later) were reshaped so as to have a rectangular shape of 30 mm × 10 mm as viewed in a plan view and these materials were prepared as Samples respectively.

### 2) Experiment Method

First, the Sample that corresponds to an experiment number was disposed on the sample fixing base 740. At this point of time, whichever experiment number the Sample takes, the position of the sample fixing base 740 is adjusted such that the gap G becomes approximately 1 mm.

Next, the pair of permanent magnets 730 was lifted to a state indicated by a solid line in FIG. 8 such that a height of the center of the pair of permanent magnets 730 agrees with a height of the rotary shaft AX2 (that is, the rod 710 becomes horizontal).

Next, the pendulum was released.

Then, the pair of permanent magnets 730 started movement in a direction indicated by an arrow C0 in FIG. 8 and in a direction indicated by an arrow C1 and in a direction indicated by an arrow C2 just above the Sample so that the pair of permanent magnets 730 performs oscillation by moving in a reciprocating manner. Such oscillations were attenuated mainly by a loss due to the generation of an eddy current brought about when the pair of permanent magnets 730 passes an area in the vicinity of the Sample besides resistance between the pendulum and air, and soon the pair of permanent magnets 730 was stopped. Experiment data was obtained by observing this reciprocating oscillation. The contents of the observation were the number of times that the pendulum reciprocated (the number of times until the pendulum was stopped, hereinafter simply referred to as the number of reciprocation) and a time during which the pendulum was oscillated (a predetermined time until the pendulum was stopped, hereinafter simply referred to as oscillation time). Based on an assumption that the larger the number of reciprocation and/or the oscillation time, the smaller the generation of an eddy current is, it was determined that the larger the number of reciprocation and/or the oscillation time, the smaller the generation of an eddy current is small. Although the samples having the experiment numbers 6, 7 were not conductive wires, the observation was made also with respect to these samples as comparative examples. Experiments ranging from the experiment numbers 1 to 7 were performed in accordance with the above-mentioned experimental method.

### Result of Experiment

FIG. 9 is a table illustrating an experiment result of the experiment example.

As illustrated in FIG. 9, with respect to the experiment numbers 2, 4, 5 where an average diameter of the conductive base member (conductive portion) is 100 µm or less, the number of reciprocation and the oscillation time were relatively large and hence, the generation of an eddy current was small. Further, in a case where the average diameter of the conductive base member (conductive portion) is 50 µm or less, the generation of an eddy current was further reduced. Further, with respect to the experiment numbers 4, 5 that are the braided wire formed by braiding a plurality of bare conductive wires, the number of reciprocations and the oscillation time were relatively large and hence, the generation of an eddy current was small. Further, also with respect to the experiment 2 that is a magnet wire (a wire where an insulation film is applied in advance to the conductive portion that forms the conductive base member), the number of reciprocation and the oscillation time were relatively large and hence, the generation of an eddy current was small. Further, also with respect to the experiment 3 that is a plated copper wire, the number of reciprocation and the oscillation time were relatively large and hence, the generation of an eddy current was small.

### Conclusions

(4-1) From the above-mentioned result of the experiment, in forming the electromagnetic coils 1A, 1B according to the embodiment 1, it has become apparent that an average diameter of the conductive base member 10 is preferably 120 µm or less, is further preferably be 100 µm or less, and is still further preferably be 50 µm or less (experiment numbers 2, 4, 5).

2) In forming the electromagnetic coils 1A, 1B according to the embodiment 1, under the condition of the above-mentioned (1), it has become apparent that it is more preferable that the coil-use conductive wire 110A be the braided wire 20 that is formed by braiding a plurality of bare conductive wires 11 (experiments 4, 5).

3) in forming the electromagnetic coils 1A, 1B according to the embodiment 1, under the condition of the above-mentioned (1), it has become apparent that, as the coil-use conductive wire 110A, it is preferable to use a “magnet wire” where an insulation film is applied to the conductive base member 10 in advance (experiment number 2).

4) it has become apparent that, as the conductive base member 10, a nickel plated wire formed by applying nickel plating to a copper wire, and a tin plated wire formed by applying tin plating to a copper wire are also preferably used (experiment 3).

As has been described above, it has been ascertained by the experiment that, by adopting the conductive base member 10 or the coil-use conductive wire 110A that satisfies one of or the combination of the above-mentioned (4-1) to (4-4), the generation of an eddy current can be reduced.

### 4. Advantageous Effects of Electromagnetic Coils 1A, 1B According to Embodiment 1

(1) The effective coil portions 102A, 102B of the electromagnetic coils 1A,1B are formed of the coil-use conductive wires 110A, 110B each of which is formed by bundling the plurality of conductive base members 10 and hence, the generation of an eddy current can be reduced. It is because, as described in the chapter [Experiment example], in the “effective coil portion” that is liable to be affected by the movement of the magnet, by adopting the coil-use conductive wire that is formed by bundling the plurality of conductive base members without adopting a solid conductive member made of, for example, metal, (for example, a copper plate), it is expected that an eddy current can be reduced.

Further, the first coil end portions 103A, 103B and the second coil end portions 104A, 104B are not members that are formed using wire members. That is, the first coil end portions 103A, 103B and the second coil end portions 104A, 104B are formed using a solid conductive member respectively. Accordingly, unlike the conventional electromagnetic coil, the electromagnetic coil can be wound around the air core regions 101A, 101B by changing the first coil end portions 103A, 103B and the second coil end portions 104A, 104B at an acute angle from the longitudinal direction LD of the effective coil portions 102A, 102B without providing the curved portions. As a result, the coil end portions can be made small compared to the conventional electromagnetic coil.

Further, the first end members 130A, 130B and the second end members 140A, 140B are made of a solid conductive member. That is, the first end members 130A, 130B and the second end members 140A, 140B are not formed neither by kneading nor braiding and hence, there arises no problems during working steps such as disconnection of a wire or a wire diameter strain.

Accordingly, the electromagnetic coils 1A, 1B each become an electromagnetic coil that can reduce a size of a coil end portion than the prior art while reducing the generation of an eddy current and, at the same time, can prevent the occurrence of drawbacks that may occur in working steps such as a disconnection of a wire or a wire diameter strain generated in forming a coil-use conductive wire.

In other words, in the electromagnetic coils 1A, 1B according the embodiment 1, for example, the braided wires 20 are adopted at the effective coil portion (a region that is effectively affected by movement of the magnet) so that an eddy current can be reduced. On the other hand, while taking such consideration on the arrangement of the electromagnetic coils 1A, 1B, the solid conductive members are disposed at the coil end portions that are not largely affected by the movement of the magnet so that lengths and volumes that the coil end portions occupy can be reduced so that it is possible to overcome problems during working steps such as the disconnection of a wire or a wire diameter strain.

(2) As described above, by forming the coil end portion small compared to the conventional coil end portion, a resistance of the electromagnetic coil can be reduced compared to the conventional electromagnetic coil by an amount corresponding to the coil end portion. In the electromagnetic coils 1A, 1B according to the embodiment 1, provided that an excitation voltage is equal, an electric current that flows into the electromagnetic coil can be increased compared to the conventional electromagnetic coil, and a torque can be increased compared to the conventional electromagnetic coil. To describe the advantageous effect from another point of view, provided that equal torque can be obtained, the electromagnetic coils 1A, 1B can be made compact compared to the conventional electromagnetic coil (space efficiency being increased).

(3) The first end members 130A, 130B and the second end members 140A, 140B are each formed of a solid conductive material and hence, these end members can be formed to have suitable profiles. Accordingly, in a case where the coil assembly 100 is formed by combining the electromagnetic coils having different shapes, particularly also in a case where a coil core assembly is formed using electromagnetic coils each having a complicated stereoscopic shape such that profiles sharply change as in the case of the winding direction switching portions 134A, 134B, the inner diameter protruding portion 135A, the outer diameter protruding portion 145B, according to the embodiment 1, such an electromagnetic coil can be formed relatively easily.

(4) The first end members 130A, 130B are fixed to one end side of the coil-use conductive wires 110A, 110B by crimping, and the second end members 140A, 140B are fixed to the other end side of the coil-use conductive wires 110A, 110B by crimping. Accordingly, these constitutional elements can be simply connected to each other without requiring a heat source such as welding and hence, it is possible to provide the electromagnetic coils 1A, 1B having excellent productivity.

Further, although not introduced as the embodiment of the present invention, in a case where the connection and fixing between the first end member 130A and the coil-use conductive wire 110A and the connection and fixing between the second end member 140A and the coil-use conductive wire 110A are made by “welding”, an oxide film is formed at welded portions. Accordingly, when a large current supplied to the electromagnetic coil, a problem that Joule heat generated by a resistance component in the welded portion becomes large is liable to occur. On the other hand, fixing by crimping does not cause such a drawback.

(5) In the embodiment 1, it is preferable that the insulation layers 106A, 106B in the effective coil portions 102A, 102B be formed of an insulation layer that is formed by solidification of a water soluble material that impregnates into a periphery of the conductive base member 10.

In a case where the insulation layers 106A, 106B are formed of an insulation coating film to which an insulation coating material is coated, the insulation withstand voltage characteristic is liable to be affected by sagging of the insulation coating material in a liquid form, the non-uniform adhesion of the insulation coating material on the base member and the like at the time of coating. On the other hand, by forming the insulation layers 106A, 106B using an insulation layer that is formed by solidifying a water soluble material that impregnates into peripheries of the conductive base members 10, the water-soluble material reaches areas between conductive base members in the coil-use conductive wires 110A, 110B because of an impregnation effect so that gaps between the copper wire base members are filled with the water-soluble material. Accordingly, there is no possibility that the sagging of the insulation coating material in a liquid form and the non-uniform adhesion occur. Accordingly, the homogeneous insulation layer can be formed irrelevant to portions of the electromagnetic coil. As a result, the electromagnetic coil can acquire a homogeneous insulation withstand voltage characteristic and hence, it is possible to obtain a high-quality electromagnetic coil having a stable insulation characteristic.

Further, it is further preferable that the insulation layers 106A, 106B in the effective coil portions 102A, 102B are each formed of an electro-deposition insulation coating film that is formed on a periphery of the conductive base member 10.

An electro-deposition coating film is formed by completely immersing an object to be coated in an electro-deposition coating solution, and by applying a predetermined voltage to the object to be coated. The impregnation of the electro-deposition coating solution is performed such that the electro-deposition coating solution reaches both an outer side and an inner side of the coil-use conductive wires 110A, and a voltage is applied not only to the conductive base members 10 positioned on the outer side of the coil-use conductive wires 110A, 110B but also to the conductive base members 10 positioned on the inner side of the coil-use conductive wires 110A, 110B and hence, the homogeneous insulation layers 106A, 106B are obtained from the outer side to the inner side of the coil-use conductive wire 110A can be obtained. As a result, the homogeneous withstand voltage characteristic can be obtained irrespective of the portions of the electromagnetic coil and hence, it is possible to obtain a high-quality electromagnetic coil having a stable insulation characteristic.

### Embodiment 2

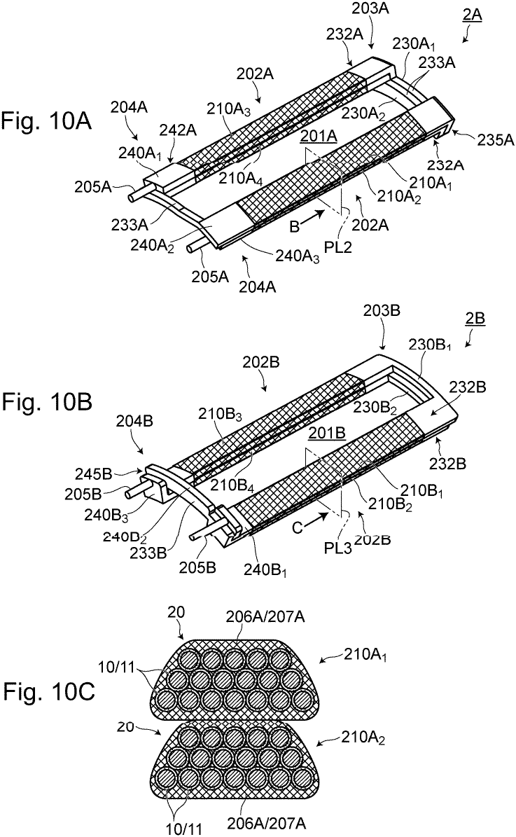

FIGS. 10A to 10C are views illustrating electromagnetic coils 2A, 2B according to an embodiment 2. FIG. 10A is a perspective view of the electromagnetic coil 2A (first-shape coil 2A), and FIG. 10B is a perspective view of the electromagnetic coil 2B (second-shape coil 2A). With respect to constitutional elements having the same basic configurations and technical features as the corresponding constitutional elements of the embodiment 1, while exchanging the numeral on the triple digits in the embodiment 1 from 1 to 2 (the digit of 100 in the embodiment 1 and the digit of 200 in the embodiment 2), the description of the corresponding constitutional elements in the embodiment 1 are used, and the repeated description is omitted in this embodiment.

The electromagnetic coils 2A, 2B according to the embodiment 2 have substantially the same configuration as the electromagnetic coils 1A, 1B according to the embodiment 1. However, The electromagnetic coils 2A, 2B according to the embodiment 2 differ from the electromagnetic coils 1A, 1B according to the embodiment 1 with respect to the number of turns of “conductive members”.

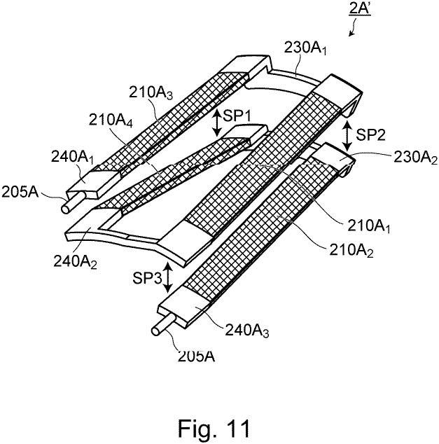

For example, as illustrated in FIG. 10A, with respect to the electromagnetic coil 2A, “conductive member” is wound around an air core region 201A by approximately two turns by connecting a second end member 240A₁, a coil-use conductive wire 210A₃, a first end member 230A₁, a coil-use conductive wire 210A₁, a second end member 240A₂, a coil-use conductive wire A₄, a first end member 240A₂, a coil-use conductive wire A₂, and a second end member 240A₃ in this order from a left front side (strictly speaking, the “conductive member” being wound by 1 plus ¾ turns, see also FIG. 11 described later).

Corresponding to such a configuration, four coil-use conductive wires 210A are used, modes of the first end members 230A₁, 230A₂ differ from each other, and modes of the second end members 240A₁, 240A₂, 240A₃ differ from each other. Particularly, the second end member 240A₂ includes a winding direction switching portion (indication by a symbol being omitted) and a bridge portion 233A so that the coil-use conductive wire 210A₁ and the coil-use conductive wire 210A₂ are electrically connected to each other. However, the basic configuration of the electromagnetic coil 2A is formed based on the substantially same design concept as the electromagnetic coil 1A according to the embodiment 1 and hence, the electromagnetic coil 2A has the same basic configuration as the electromagnetic coil 1A.

As illustrated in FIG. 10B, The electromagnetic coil 2B also has substantially the same configuration as the electromagnetic coil 1B according to the embodiment 1. That is, “conductive member” is wound around an air core region 201B by approximately two turns.

FIG. 10C is a cross-sectional view of the effective coil portion 202A of the electromagnetic coil 2A obtained by cutting the effective coil portion 202A along an imaginary plane PL2 illustrated in FIG. 10A and by viewing the cross section along an arrow B.

As illustrated in FIG. 10C, the cross section of the effective coil portion 202A in the electromagnetic coil 1A has a shape where the coil-use conductive wire 210A₁ and the coil-use conductive wire 210A₂ are stacked in two stages. To observe the coil-use conductive wire 210A₁ and the coil-use conductive wire 210A₂ individually, these coil-use conductive wires have the same structure as the coil-use conductive wire 110A according to the embodiment 1.

A cross-sectional view of the effective coil portion 202B of the electromagnetic coil 2B substantially becomes equal to FIG. 10C. Accordingly, the illustration and the description of the cross-sectional structure of the effective coil portion 202B of the electromagnetic coil 2B are omitted.

A method of manufacturing the electromagnetic coils 2A, 2B adopts substantially the same steps as the method of manufacturing the electromagnetic coils 1A, 1B of the embodiment 1 (see FIG. 5 to FIG. 7C). However, modification is necessary with respect to the insulation layer forming step S180.

FIG. 11 is a view illustrating a state of an electromagnetic coil 2A′ in the insulation layer forming step S180 according to the embodiment 2.

As described above, in the electromagnetic coils 2A, 2B, the “conductive member” is wound around by two turns (2T). Accordingly, in a case where an attempt is made to form an insulation layer in a state where the “conductive member” of first turn and the “conductive member” of second turn are brought into close contact with each other, there is a concern that the insulation layer cannot be formed between the “conductive member” of first turn and the “conductive member” of second turn.

In view of the above, as illustrated in FIG. 11, in performing the insulation layer forming step S180, impregnation, adhesion, coating and the like of an insulation material are applied to the conductive members (the coil-use conductive wire 210A, the first end member 230A, the second end member 240A, index numbers being omitted) in a state where a space is formed between the “conductive member” of first turn and the “conductive member” of second turn such that, for example, a space indicated by SP1 is formed between a coil-use conductive wire 210A2 and a coil-use conductive wire 210A4, a space indicated by SP2 is formed between a first end member 230A₁ and a first end member 230A₂, and a space indicated by SP3 is formed between a second end member 240A₁ and a second end member 240A₂.

The electromagnetic coils 2A, 2B according to the embodiment 2 have substantially the same configuration as the electromagnetic coils 1A, 1B according to the embodiment 1 except for the number of turns of the “conductive member”. Accordingly, the electromagnetic coils 2A, 2B according to the embodiment 2 directly acquire the corresponding advantageous effects found amongst all advantageous effects that the electromagnetic coils 1A, 1B according to the embodiment 1 acquires.

### Embodiment 3

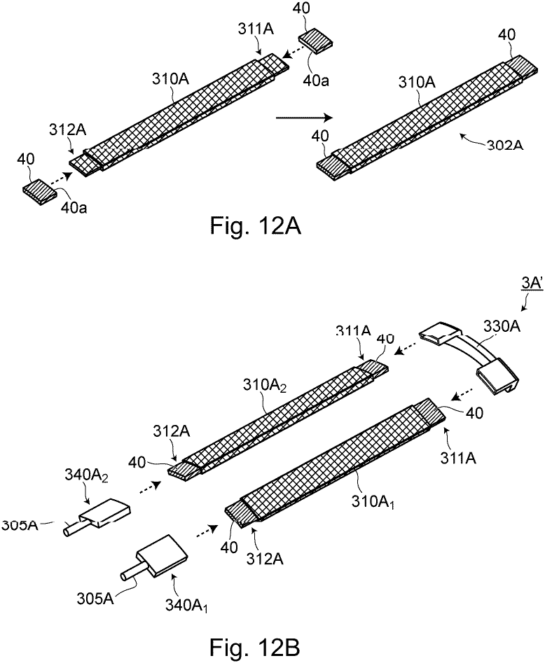

FIGS. 12A and 12B are views (perspective view) illustrating manufacturing steps (some steps) of an electromagnetic coil 3A according to the embodiment 3. With respect to constitutional elements having the same basic configurations and technical features as the corresponding constitutional elements of the embodiment 1, while exchanging the numeral on the triple digits in the embodiment 1 from 1 to 3 (the digit of 100 in the embodiment 1 and the digit of 300 in the embodiment 3), the description of the corresponding constitutional elements in the embodiment 1 are used, and the repeated description is omitted in this embodiment.

The electromagnetic coils 3A, 3B according to the embodiment 3 have substantially the same configuration as the electromagnetic coils 1A, 1B according to the embodiment 1. However, the electromagnetic coils 3A, 3B according to the embodiment 3 differ from the electromagnetic coils 1A, 1B according to the embodiment 1 with respect to a point that a spacer 40 is mounted on an end portion of a coil-use conductive wire 310A.

That is, although the illustration of an assembled state of the electromagnetic coils 3A, 3B is omitted, a spacer 40 is mounted on end portions (one end side 311A, the other end side 312A) of a coil-use conductive wire 310A. The end portions ( one end side 311A, the other end side 312A) are connected to a first end member 330A and second end members 340A₁, 340A₂ to each other respectively. In other words, the first end member 330A and the coil-use conductive wire 310A are connected to each other via the spacer 40. Further, the second end members 340A₁, 340A₂ and the coil-use conductive wire 310A are connected to each other via the spacer 40. Although not illustrated in the drawings, an outer size of the spacer 40 is designed to as to correspond to inner sizes of an opening portion 331A of the first end member 330A and an opening portion 341A of a second end member 340A, and the spacer 40 and the opening portion 331A and the opening portion 341A are configured to engage with each other by fitting engagement.

A method of manufacturing the electromagnetic coils 3A, 3B require a spacer mounting step as a new step.

As illustrated in a left side view in FIG. 12A, in a braided wire forming step S134 is performed in a coil-use conductive wire setup step S130 and, thereafter, the spacer 40 is mounted on one end side 311A and the other end side 312A of the coil-use conducive wire 310A (spacer mounting step). Specifically, the spacer 40 is inserted into one end side 311A and the other end side 312A of the coil-use conductive wire 310A respectively, and the spacers 40 are fixed to the one end side 311A and the other end side 312A by “crimping” by applying a pressure from the outside of the respective spacers 40 using a crimping jig. Further, instead of “crimping” or in addition to “crimping”, fixing may be performed by welding using a conductive adhesive agent. Whichever method is taken, after fixing is performed, a state described on a right side in FIG. 12A is obtained.

Thereafter, as shown in FIG. 12B, in the same manner as the first end member insertion step S140 and the second end member insertion step S160 according to the embodiment 1, the end portions of the coil-use conductive wire 310A on which the spacer 40 is mounted can be inserted into the opening portions 331A of the first end member 330A and the opening portions 341A of the second end members 340A₁, 340A₂.

By manufacturing the electromagnetic coils 3A, 3B in this manner, the first end member 330A and the coil-use conductive wire 310A are “indirectly connected to each other” via the spacer 40. Further, the second end members 340A and the coil-use conductive wire 310A are “indirectly connected to each other” via the spacer 40.

Also in this case, the first end member 330A or the second end member 340A and the coil-use conductive wire 310A can be connected to each other by crimping.

In a case where, for example, a braided wire is adopted as the coil-use conductive wire 310A, an end portion of the braided wire can be directly inserted into and fitted into the opening portion 331A of the first end member 330A. However, there is a possibility that a fray, a fluff or the like of the conductive base member 10 (wire member) is generated at an end portion of the braided wire.

On the other hand, in the embodiment 3, in the above-mentioned case, the spacer 40 is temporarily mounted on the end portion of the braided wire by introducing the spacer 40 and hence, such fray, fluff and the like can be eliminated and hence, the electromagnetic coil having higher connection reliability can be obtained.

The electromagnetic coils 3A, 3B according to the embodiment 3 have substantially the same configuration as the electromagnetic coils 1A, 1B according to the embodiment 1 except for a point that the spacer 40 is mounted on the end portion of the coil-use conductive wire (see FIG. 5 to FIG. 7C). Accordingly, the electromagnetic coils 3A, 3B according to the embodiment 3 directly acquire the corresponding advantageous effects found amongst all advantageous effects that the electromagnetic coils 1A, 1B according to the embodiment 1 acquire.

### Embodiment 4

Electromagnetic coils 4A, 4B according to the embodiment 4 basically have substantially the same configuration as the electromagnetic coils 2A, 2B according to the embodiment 2. However, the electromagnetic coils 4A, 4B according to the embodiment 4 differ from the electromagnetic coils 2A, 2B according to the embodiment 2 with respect to a point that a spacer 40 is mounted on an end portion of a coil-use conductive wire (omitted in the drawing).

That is, in the electromagnetic coils 4A, 4B according to the embodiment 4, the number of turns of “conductive member” is approximately two times (the configuration substantially equal to the configuration of the electromagnetic coils 2A, 2B according to the embodiment 2), and a spacer 40 is mounted on both ends of the coil-use conductive wire 410 in the same manner as the embodiment 3. That is, the spacer 40 is mounted on the end portion of the coil-use conductive wire 410A, and the end portion of the coil-use conductive wire 410A is connected to the first end member 430A and the second end member 440A respectively. In other words, the first end member 430A and the coil-use conductive wire 410A are connected to each other via the spacer 40. Further, the second end member 440A and the coil-use conductive wire 410A are connected to each other via the spacer 40 (omitted from the drawing).

The electromagnetic coils 4A, 4B according to the embodiment 4 have substantially the same configuration as the electromagnetic coils 2A, 2B according to the embodiment 2 except for a point that the spacer 40 is mounted on the end portion of the coil-use conductive wire. The electromagnetic coils 4A, 4B according to the embodiment 4 directly acquire the corresponding advantageous effects found amongst all advantageous effects that the electromagnetic coils 2A, 22B according to the embodiment 2 acquire.

### Modification

Although the present invention has been described with reference to the above-mentioned embodiments heretofore, the present invention is not limited to the above-mentioned embodiments. The present invention can be carried out in various modes without departing from the gist of the present invention. For example, the following modifications are also possible.

(1) In the respective embodiments, the connection and fixing between the first end member or/and the second end member and the coil-use conductive wire are described by taking fixing by crimping as an example. However, the present invention is not limited to such connection and fixing.

For example, the solid conductive member may be made of metal, the first end member may be fixed to one end side of the coil-use conductive wire by welding, and the second end member may be fixed to the other end side of the coil-use conductive wire by welding. In this modification, “fixing by welding” means fixing by melting metal powder of silver, tin or the like by heating and hence, so-called soldering is also included in the fixing by welding according to the present invention. By adopting fixing by welding, a space between the first end member/ the second end member and the coil-use conductive wire is filled with a welding material and hence, it is possible to provide an electromagnetic coil where a contact resistance is reduced so that connection reliability is enhanced.

Further, for example, the solid conductive material may be metal, the first end member may be fixed to one end side of the coil-use conductive wire by a conductive adhesive agent, and the second end member may be fixed to the other end side of the coil-use conductive wire by a conductive adhesive agent. In this modification, “fixing by a conductive adhesive agent” means that, for example, bonding is performed by applying a silver paste (a grease containing silver powder) or the like to a bonding portion and, thereafter, fixing is performed by hardening the bonding portion by eliminating organic components by heating. In the same manner as welding, a space between the first end member/the second end member and the coil-use conductive wire can be filled with the adhesive agent and hence, it is possible to provide an electromagnetic coil where a contact resistance is reduced so that high connection reliability is obtained.

(2) In the respective embodiments, the description has been made with respect to the example where the braided wire 20 that uses the bare conductive wires 11 as the conductive base members 10 is adopted as the coil-use conductive wire. However, the present invention is not limited to such a case.

For example, the conductive base members 10 may be enameled wires 12, and the coil-use conductive wire may be formed of “a litz wire 30” obtained by twisting (stranding) a plurality of enameled wires 12 (omitted from the drawing).

The so-called litz wire 30 is cheaper than the braided wire 20 and hence, the litz wire 30 is attractive from a view point of industrial use. However, the litz wire 30 is weak against bending and hence, drawbacks are liable to occur in working steps such as disconnection of a wire or a wire diameter strain by forming and hence, it has been difficult to adopt the litz wire 30 as the coil-use conductive wire conventionally. However, according to the present invention, the coil-use conductive wire is not used in the coil end portions and is incorporated only in the effective coil portion having a straight-line shape and hence, the litz wire 30 can be adopted without taking into account the above-mentioned drawbacks. Accordingly, the litz wire 30 can be preferably used in the present invention thus realizing an economical electromagnetic coil.

(3) In the respective embodiments, the description has been made with respect to the example where “the conductive member” is wound by approximately one turn (1T) or by approximately two turns (2T). However, the present invention is not limited to such an example. For example, “the conductive member” may be wound by three or more turns. However, in the present invention, the electromagnetic coil where the number of turns of “the conductive member” is two turns or less is more preferable. When “the conductive member” is wound by three or more turns, the degree of difficulty of a step of applying an insulation coating agent between the coil-use conductive wires that are stacked in stages (the braided wire or the like) is increased. When the number of turns of “the conductive member” is two or less times, it is possible to provide the electromagnetic coil that exhibits excellent manufacturing property thus being advantageous also from an economical point of view.

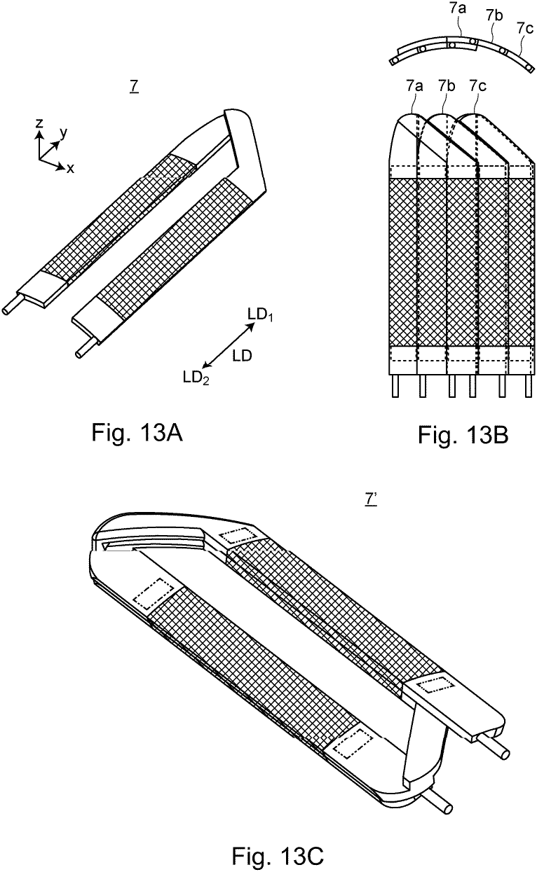

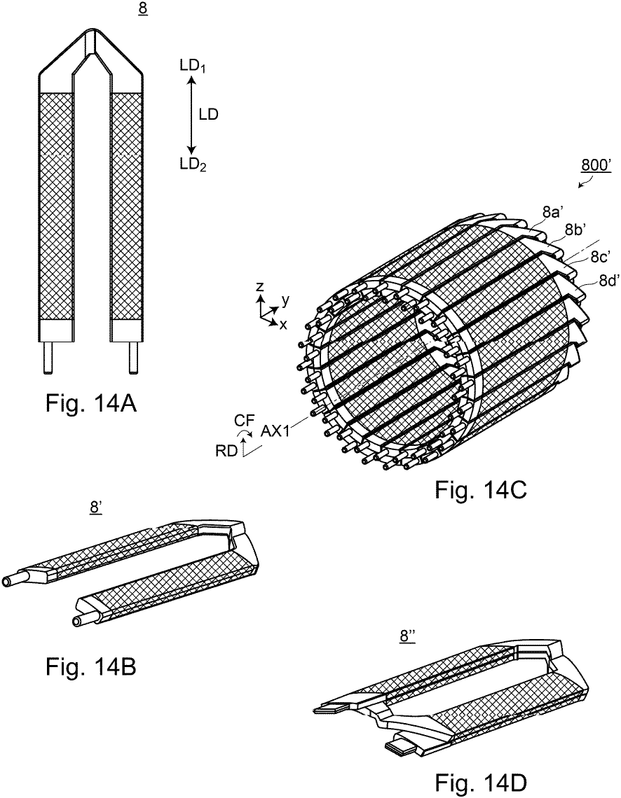

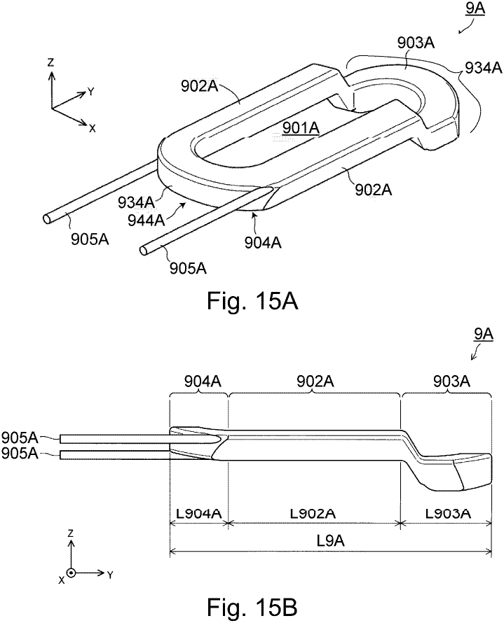

In the respective embodiments, with respect to the electromagnetic coil that is configured such that, in the air core region of “one magnetic coil” to which an electric current of a first phase is supplied, the effective coil portion of “the other electromagnetic coil” to which an electric current of a second phase is supplied is fitted, the description has been made by introducing the electromagnetic coils 1A, 1B having the structure illustrated in FIGS. 1A to 2B, FIGS. 7A to 7C, FIGS. 10A to 11 and the like. However, the present invention is not limited to such a configuration. For example, electromagnetic coils 7,7′ having the structure illustrated in FIGS. 13A to 13C and electromagnetic coils 8, 8′, 8″ having the structure illustrated in FIGS. 14A to 14D may also applicable as an electromagnetic coil that is configured such that, in an air core region of “one electromagnetic coil” to which an electric current of a first phase is supplied, an effective coil portion of “the other electromagnetic coil” to which an electric current of a second phase is supplied is fitted.

FIGS. 13A to 13C are views illustrating the electromagnetic coils 7, 7′ according to the modification. The description in Japanese Patent Application 2020-147041 in which the inventors of the present patent application are listed as the inventors can be used as the description of these electromagnetic coils. FIGS. 14A to 14D are views illustrating the electromagnetic coils 8, 8′, 8″ according to the modification. Symbol 800′ indicates an example of a coil assembly that uses the electromagnetic coil 8′ . The description of Japanese Patent Application 2021-98086 in which the inventors of the present patent application are listed as the inventors can be used as the description of the electromagnetic coils 8, 8′, 8″.

In the respective embodiments, the description has been made by taking the electromechanical device that is operated by being excited at two phases as an example (FIGS. 1A to 1D and the like). However, the present invention is not limited to such an example. For example, the present invention is also applicable to the electromechanical device that is excited at three phases.

(6) The description has been made with respect to the example where the coreless motor is used as the object to which the present invention is applied. However, the present invention is not limited to such an example. For example, the present invention is applicable to electromechanical devices in general such as a coreless type generator, a regenerative brake and an actuator. Further, an object to which the present invention is applicable is not limited to a coreless (having no core) electromechanical device. The present invention may be applied to a cored (having a core and arranging the electromagnetic coil around the core) electromechanical device.

(7) In the respective embodiments, the description has been made by taking the electromechanical device that is realized on a premise of the rotation of a coreless motor or the like as an example. However, the present invention is not limited to such an example. For example, the present invention can be used in a linear-type electromechanical device. For example, by allowing the electromechanical device to have the configuration where one portion of the cage coil assembly illustrated in FIG. 1A is imaginarily cut and developed in a circumferential direction, it is also possible to provide a coil assembly for a linear type electromechanical device. In this case, the rotor (rotator) in this specification may be also referred to as a mover (a mobile element).

1. An electromagnetic coil where a member having conductivity is wound around an air core region, and the member is disposed along a moving direction of a magnet of an electromagnetic device, wherein
the electromagnetic coil includes: an effective coil portion; a first coil end portion positioned on one side of the effective coil portion in a longitudinal direction; and a second coil end portion positioned on the other side of the effective coil portion in the longitudinal direction,
the effective coil portion is formed of a coil-use conductive wire formed by bundling a plurality of conductive base members,
the first coil end portion is formed of a first end member that is a solid conductive member,
the first end member is connected to respective one end sides of one coil-use conductive wire and the other coil-use conductive wire that form the effective coil portion, the first end member being electrically connected between the one coil-use conductive wire and the other coil-use conductive wire,
the second coil end portion is formed of a second end member that is a solid conductive member,
the second end member being connected to the other end side of at least one of the coil-use conductive wires that form the effective coil portion, and
in the air core region of “one said electromagnetic coil” to which an electric current of a first phase is supplied, “the other said electromagnetic coil” to which an electric current of a second phase is supplied is fitted.

2. An electromagnetic coil where a member having conductivity is wound around an air core region, and the member is disposed along a moving direction of a magnet of an electromagnetic device, wherein
the electromagnetic coil includes: an effective coil portion; a first coil end portion positioned on one side of the effective coil portion in a longitudinal direction; and a second coil end portion positioned on the other side of the effective coil portion in the longitudinal direction,
the electromagnetic coil includes electromagnetic coils of two modes consisting of: a first-shape coil having a shape where the first coil end portion is bent toward a first side from the longitudinal direction; and a second-shape coil having a shape where the second coil end portion is bent toward a second side on a side opposite to the first side from the longitudinal direction,
the first-shape coil and the second-shape coil are configured such that, in the air core region of either one of the first-shape coil and the second-shape coil, the effective coil portion of the other of the first-shape coil and the second-shape coil is disposed by combining the first-shape coil and the second-shape coil,
the effective coil portion is formed of a coil-use conductive wire formed by bundling a plurality of conductive base members,
the first coil end portion is formed of a first end member that is a solid conductive member,
the first end member is connected to respective one end sides of one coil-use conductive wire and the other coil-use conductive wire that form the effective coil portion, the first end member being electrically connected between the one coil-use conductive wire and the other coil-use conductive wire,
the second coil end portion being formed of a second end member that is a solid conductive member, and
the second end member being connected to the other end side of at least one of the coil-use conductive wires that form the effective coil portion.

3. The electromagnetic coil according to claim 1 wherein
a spacer is mounted on an end portion of the coil-use conductive wire, and the end portion of the coil-use conductive wire is connected to the first end member and the second end member.

4. The electromagnetic coil according to claim 1, wherein
the solid conductive material is metal,
the first end member is fixed to one end side of the coil-use conductive wire by crimping, and
the second end member is fixed to the other end side of the coil-use conductive wire by crimping.

5. The electromagnetic coil according to claim 1, wherein
the solid conductive material is metal,
the first end member is fixed to one end side of the coil-use conductive wire by welding, and
the second end member is fixed to the other end side of the coil-use conductive wire by welding.

6. The electromagnetic coil according to claim 1, wherein
the solid conductive material is metal,
the first end member is fixed to one end side of the coil-use conductive wire using a conductive adhesive agent, and
the second end member is fixed to the other end side of the coil-use conductive wire using a conductive adhesive agent.

7. The electromagnetic coil according to claim 1, wherein
a wire used as the conductive base member is a conductive wire containing copper, and an average radius of the conductive base member is 120 µm or less.

8. The electromagnetic coil according to claim 7, wherein
the conductive base member is a bare conductive wire, and
the coil-use conductive wire is a braided wire formed by braiding a plurality of the bare conductive wires.

9. The electromagnetic coil according to claim 7, wherein
the conductive base member is an enameled wire, and
the coil-use conductive wire is “a litz wire” formed by twisting a plurality of the enameled wires.

10. The electromagnetic coil according to claim 1, wherein
a circuit connection terminal that is continuously formed with or is connected to the second end member is disposed on the second coil end portion, and
an insulation layer is formed on a surface of an entire region of the electromagnetic coil except for the circuit connection terminal.

11. The electromagnetic coil according to claim 10, wherein
the insulation layer formed on the effective coil portion is an insulation layer that is formed by solidification of a water soluble material that impregnates into a periphery of the conductive base member.

12. The electromagnetic coil according to claim 11, wherein
the insulation layer formed on the effective coil portion is an electro deposited insulation coating film formed on the periphery of the conductive base member.

13. The electromagnetic coil according to claim 10, wherein
the insulation layer formed on the effective coil portion is an insulation coating film formed on the periphery of the conductive base member.
